(19) United States
(12) Patent Application Publication
(10) Pub. No.: US 2026/0018319 A1
(43) Pub. Date: Jan. 15, 2026

(54) HYPERCONDUCTING ARRANGEMENT

(71) Applicant: GKN AEROSPACE SERVICES LIMITED, Solihull (GB)

(72) Inventors: Simon Taylor, Solihull (GB); Daniel Malkin, Solihull (GB)

(21) Appl. No.: 18/881,733

(22) PCT Filed: Jul. 5, 2023
(86) PCT No.: PCT/GB2023/051776

§ 371 Date: Jan. 7, 2025

(30) Foreign Application Priority Data
Jul. 8, 2022 (GB) 2210075.4

(51) Int. Cl. H01B 12/16; B64D 47/00

(52) U.S. Cl. CPC H01B 12/16; B64D 47/00; B64D 2221/00

(57) ABSTRACT

The present invention relates to an electrical transmission comprising: an electrical conductor; and, a cryogen carrying portion arranged so that, in use, cryogen is carried in the cryogen carrying portion to maintain the conductor in a hyperconductive state.

### TECHNICAL FIELD

The present invention is concerned with electrical transmission. In particular, to electrical transmissions that can be improved in efficiency by virtue of cooling using liquid hydrogen or other cryogens. It is known that the trait of superconductivity can enable highly efficient electrical transmission as the electrical resistance of certain materials drops to zero below a critical temperature.

This superconducting behaviour has a large number of benefits such as high component efficiency, low heat loss and the use of liquid hydrogen is a known way to maintain the superconducting behaviour of components.

Propulsive systems are now turning to alternative fuels to reduce environmental impact of emissions. Electrically powered vehicles and hydrogen-powered vehicles are currently in development for wider use.

In particular, in aircraft, while hydrogen-powered flight has been discussed there is a leaning in the industry towards use of gas turbines for propulsion for many technical reasons. These reasons include the ability to account for the additional power required at take off and climb stages of flight as well as being reasonably effective and efficient during cruise.

Therefore, while there are recognized environmental benefits from the use of alternative fuels, these are not yet widespread. Gains in efficiencies that can be provided using superconducting materials are not yet accepted as a solution strong enough to encourage deviation from typical fuels and standard combustion. However, where alternative, cryogenic fuels are used, obtaining the advantages possible from superconducting arrangements is very attractive.

In order to encourage use of alternative fuels, and thereby reduce environmental impact of transport by vehicles, whether on land, in sea or in air, developments are required.

Aircraft, or other vehicle, bus bars and power cables are specific examples of electrical transmissions. Such examples are isolated elements that are typically, but in the case of bus bars not always, electrically isolated by a dielectric layer or insulation layer. In those non-isolated cases, the systems are contained in high voltage boxes or bays with appropriate hazard warnings.

The inventors of an invention described herein have created a new solution for provision of low temperature electrical efficiencies that may be used with alternative fuel arrangements for vehicles to make alternative fuels more attractive.

### SUMMARY OF THE INVENTION

Aspects of the invention are set out in the accompanying claims.

Viewed from first aspect there is provided an electrical transmission comprising: an electrical conductor; and, a cryogen carrying portion arranged so that, in use, cryogen is carried in the cryogen carrying portion to maintain the conductor in a hyperconductive state.

Such an arrangement enables conduction of both electricity and cryogen. In this way the conductor is maintained in a state that is highly electrically efficient, while avoiding the drawbacks of superconductivity.

In an example, the cryogen carrying portion is formed by the electrical conductor. This arrangement is a particularly space efficient solution.

In an example, in use, the cryogen carried in the cryogen carrying portion is arranged to provide an electrically insulating function. This provides additional resilience in the arrangement against an electrical short. Furthermore, this advantage is provided by an element already used in some present systems, but in a manner that has not been disclosed previously.

In an example, the transmission further comprises: a second electrical conductor; and, a cryogen returning portion formed between the electrical conductor and the second electrical conductor, the cryogen returning portion arranged so that, in use, a cryogen is returned in the portion formed between the electrical conductor and the second electrical conductor. This arrangement allows for outward and inward paths for cryogen and provides a closed circuit system which therefore does not require additional cryogen to be provided. Furthermore, the return cryogen may provide a dielectric protective element to further electrically shield more central conductors carrying current.

In an example, the cryogen returning portion is arranged between the cryogen carrying portion and an outer edge of the electrical transmission. In this arrangement, the cryogen return portion thermally insulates the cryogen carrying portion which is closer to the inside of the transmission and which crucially operates at a colder temperature. Therefore, it decreases the requirements for keeping the outbound cryogen cool via use of the returning cryogen.

In an example, the transmission further comprises a former arranged to abut the electrical conductor. Use of the former reduces the total amount of conductor needed in the transmission and therefore reduces cost of the arrangement.

In an example, the transmission further comprises a support structure arranged to support the electrical conductor. This arrangement increases the structural strength of the transmission thereby increasing resilience to damage and increasing reliability. This arrangement also improves the reliability of the positioning of the metal conductor. The supports assist in prevention of movement of the conductor, which in turn improves reliability of consistent overall cooling of the cryogen.

In an example, the transmission further comprises electrical insulation arranged to form an outer layer of the electrical transmission. This arrangement decreases the likelihood of electrical shorting or generally impacting nearby electrical equipment. This arrangement also increase the safety of the transmission.

In an example, the transmission further comprises a dielectric arranged to provide electrical insulation within the electrical transmission. Such a material is an advantageous choice for electrical insulation within such an electrical transmission.

In an example, the electrical conductor is formed of aluminium. Aluminium has shown advantageous properties for the arrangement as described herein.

In an example, the transmission further comprises a first electrical transmission portion; a second electrical transmission portion; and, a clamp, wherein the first electrical transmission portion and the second electrical transmission portion are connected by the clamp. This arrangement improves the flexibility in design of the transmission. In turn, this increases the ease of manufacture of the transmissions. By forming a transmission from a series of clamped portions the device can be constructed more simplistically (several shorter portions) and with less likelihood of any one portion being susceptible to breakage or defects or the like. This then also increases the configurations that the transmission can take (as opposed to one long rigid transmission), thereby increasing the ease of insertion into any one specific space or the like.

In an example, the transmission further comprises an insulating interrupter, arranged between the first electrical transmission portion and the second electrical transmission portion. The interrupter provides a break in the conducting circuit, such that greater control over the conductive path can be obtained.

In an example, the electrical transmission comprises a T- or Y-junction. Such an arrangement may be beneficial when introduced into specific spaces, and for control over the electrical path of the transmission. Such a junction also allows the transmission to provide cryogen and electricity to more areas (via the two branching sub-transmissions). This is therefore easier to manufacture and provide than via two separate transmissions.

Viewed from another aspect there is provided an aircraft electrical system comprising any of the electrical transmissions described above. Use of the transmission in an aircraft electrical system specifically is advantageous as the cryogen may already be present in an aircraft that utilises fuel cells or the like. There are clear synergistic advantages from inclusion of the transmission in an aircraft electrical system.

Viewed from another aspect there is provided an aircraft comprising any of the electrical transmissions described above. Use of the transmission in an aircraft specifically is advantageous as the cryogen may already be present in an aircraft that utilises fuel cells or the like. There are clear synergistic advantages from inclusion of the transmission in an aircraft.

Viewed from another aspect there is provided a method of carrying electrical signals along an electrical transmission: cooling, with a cryogen, a conductor to the hyperconductive region; providing an electrical signal to conductor; continuing to cool conductor; thermally and electrically insulating the conductor. Use of the hyperconductive region instead of the presently used superconductive maintains high performance but reduces the risks associated with superconductivity. This is a more secure but reliably performing method than presently known.

### BRIEF DESCRIPTION OF THE DRAWINGS

One or more embodiments of the invention will now be described, by way of example only, and with reference to the following figures in which:

FIG. 1A shows a schematic cross-sectional view of a standard electrical transmission arrangement for a vehicle;

FIG. 1B shows a schematic cross-sectional view of a new electrical transmission arrangement for a vehicle;

FIG. 2A shows a schematic cross-sectional view of a new electrical transmission arrangement for a vehicle;

FIG. 2B shows a simplified, enlarged version of portion D of FIG. 2A which shows a new electrical transmission arrangement for a vehicle;

FIG. 3A shows a schematic cross-sectional view of a new electrical transmission arrangement for a vehicle;

FIG. 3B shows a simplified, enlarged version of portion E of FIG. 3A which shows a new electrical transmission arrangement for a vehicle;

FIG. 4A shows a schematic cross-sectional view of a new electrical transmission arrangement for a vehicle;

FIG. 4B shows a simplified, enlarged version of portion F of FIG. 4A which shows a new electrical transmission arrangement for a vehicle;

FIG. 5 shows a schematic view of a spigot and socket joint between two portions of a transmission.

FIG. 6 shows a schematic of a joint between two portions of a transmission.

FIG. 7A shows a schematic view of a new electrical transmission arrangement, with a junction, for a vehicle;

FIG. 7B shows a schematic view of a new electrical transmission arrangement, with a junction, for a vehicle;

FIG. 8A shows a schematic cross-sectional view of a new electrical transmission arrangement for a vehicle;

FIG. 8B shows a simplified, enlarged version of portion J of FIG. 8A which shows a new electrical transmission arrangement for a vehicle;

FIG. 9A shows a schematic cross-sectional view of a new electrical transmission arrangement for a vehicle;

FIG. 9B shows a schematic cross-sectional view of a new electrical transmission arrangement for a vehicle; and,

FIG. 9C shows a schematic cross-sectional view of a new electrical transmission arrangement for a vehicle.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The invention is further described with reference to the following examples. It will be appreciated that the invention as claimed is not intended to be limited in any way by these examples. It will also be recognised that the invention covers not only individual embodiments but also combination of the embodiments described herein.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the spirit and scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

### DETAILED DESCRIPTION

An invention described herein relates to electrical transmission. In particular, this invention relates to electrically efficient, cooled electrical transmission lines. Such electrical transmission lines may be cables for conducting electricity. Cables described herein may also transport cryogens.

An electrical conductor can be cooled using cryogenic fluids such as liquid helium (below around 4 Kelvin), liquid hydrogen (between around 14 Kelvin to around than 20 Kelvin), liquid neon (between around 24 Kelvin to around 27 Kelvin), liquid nitrogen (between around 63 Kelvin to around 77 Kelvin), and liquid oxygen (between around 55 Kelvin to around 90 Kelvin). Many superconducting materials are known, these are materials with electrical resistances that drop to nothing (specifically to 0 resistance in direct current [DC] conditions, where alternating current [AC] experiences some slight resistance) once they are cooled beyond a certain “supercooled” temperature—with some consideration for the critical values for external magnetic field and current carrying.

Such materials offer high electrical efficiency transmission systems. However, there are difficulties associated with using superconduction in vehicle arrangements. In particular, superconduction relies upon the materials being permanently maintained in the superconducting phase. If the material drops out of the superconducting phase, the electrical resistance of that material increases from zero. In this instance, the current through the material with a non-zero resistance leads to heating of the material. This, in turn, leads to an increase in the resistance of the material which, again, leads to more heating. When this happens, the positive feedback loop causes a rapid increase in the temperature of the material. This heat is transferred into the nearby coolant (liquid hydrogen or the like) which is then boiled off in vast quantities. This is known in some fields as a “quench”. A “quench” can also occur if the current through the superconducting material exceeds the critical current value of the material.

Such “quench” events can be very dangerous, can severely damage electrically connected components and can waste significant amounts of cryogen. In particular, if these events were to occur on an aircraft or other similar vehicle, the safety of passengers may be compromised.

An invention described herein relates to an electrically conductive cable for efficient electrical transmission. The cable also has increased safety aspects by significantly lowering the risks associated with typical cabling solutions and superconduction. The cable disclosed within is also less space intensive than present solutions.

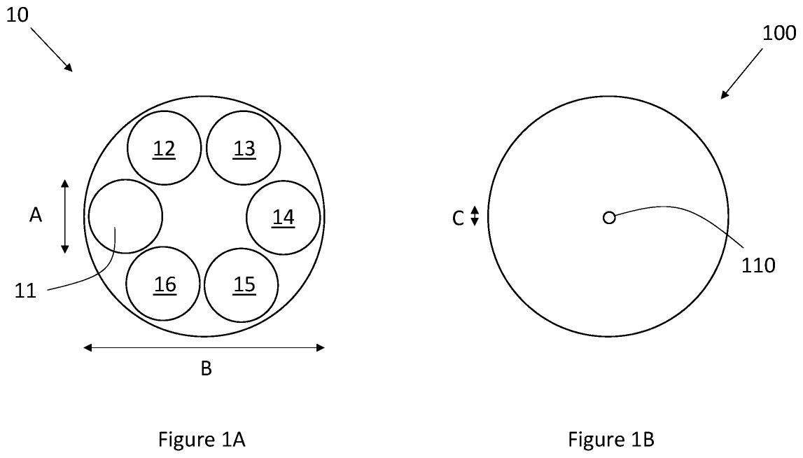

Referring now to FIG. 1A, there is shown a typical electrical transmission 10 comprising a series of cables 11, 12, 13, 14, 15, 16. Typical cables may be made of copper each having a diameter A of around 16 mm for a transmission diameter B of around 55 mm.

In common electrical buses in aircraft, conductors are in ambient air conditions or sometimes have blown air for the purpose of cooling. The heat transfer of such current carrying conductors can occur through conduction (often dominated by axial conduction into cold bays), convective cooling which is limited at flight altitudes in unpressurized bays (typically around 20,000 to 40,000 feet) or radiative thermal emission. When the conductor is hotter than a bay into which the conductor is going, heat will be lost axially. Axial conduction of heat into cold bays occurs along the conductor from one structural boundary that is warmer to one structural boundary that is colder.

For this reason, the heat transfer of such conventional bus and power cable systems is limited. Typically, power bus systems are routed in the fuselage of the aircraft and in unpressurized areas of the aircraft. This routing of the power bus is predominantly in unpressurized areas of the aircraft for aircraft that use electrical propulsion—i.e. using alternative fuels as discussed above.

Due to these limitations and to enable high power transfer of, e.g., 1 MW electrical power, the design may need 6 OFF 4/0 gauge cables of total conductor cross sectional area 643 mm² in copper. This is the arrangement shown in FIG. 1A. 4/0 here refers to the American Wire Gauge rating, where 4/0 has a diameter of 0.46 inches or 11.684 mm.

A way to reduce the joule heating effect is to utilise higher voltages. The highest DC voltage seen on aircraft today is 270V DC. For some potential electrical propulsion aircraft, voltages in the range of from 700V DC, 1 kV DC and up to around 3 kV DC are considered. These very high voltages are challenging due to partial discharge effects that can occur at voltages above 327V at any pressure or distance (327 V being the minimum breakdown voltage at any pressure or distance in air). This results in greater challenges for integration of such high voltage systems into electrical transmission arrangements.

Some modern propulsion systems utilise cryogens, such as in fuel cell systems. In such systems, there is a cryogen present that may be routed to cool the cable. In this way, the resistivity of the copper is reduced, and therefore gains can be made either in increasing the current carrying capacity of the cable or in reducing the size of the cable while keeping the current carrying capacity the same.

Modern operating temperatures for power bus systems, which are typically defined by aircraft environmental and operating conditions, are between −55 to +260° C. In this range, aluminium has a lower conductivity than copper i.e. it has a higher electrical resistance per unit area. However, in an arrangement using a cryogen it is possible to cool the temperature of the power bus system to lower temperatures than this range.

The inventors of the present invention have recognised the risks associated with the superconductive region, looked past the clear benefits from use of this region, and propose a novel system for improving electrical transmissions. Aluminium is less dense than copper and has a similar or lower resistivity than copper when at cryogenic temperatures, around less than 100 Kelvin.

Below 100 Kelvin, we refer to aluminium being in a “hyperconductive” state until the temperature reaches 1.175 Kelvin, when it becomes a superconductor. We define a hyperconductive material as a typically conductive material that undergoes a sharp or non-linear drop in specific resistivity in cryogenic temperatures (less than 100 Kelvin) without reaching a superconductive state. The present invention utilises the hyperconductive state to provide a robust but electrically efficient and effective electrical transmission system.

Aluminium is less dense than copper which means that, when comparing the size of a standard copper cabling arrangement at room temperature (FIG. 1A) against an aluminium cabling arrangement in the hyperconductive region (FIG. 1B), there is a significant decrease in the size for the cabling arrangement.

In particular, cooling the aluminium to 20 Kelvin results in a roughly 3500 fold improvement in conductivity compared to room temperature. The conductivity of aluminium at 77 Kelvin is around 324 fold higher than the conductivity of aluminium at room temperature. When the resistivity of aluminium at 20 Kelvin is compared to copper at room temperature, there is a 2246 fold increase. This equates to a reduction in mass of the conductor from aluminium or copper at room temperature to by 5000 and 2246 fold respectively. See table 1 for experimental details of resistivities for aluminium and copper at different cryogenic temperatures.

TABLE 1
Showing Resistivities of Aluminium and
Copper at Different Temperatures

| Temperature | Aluminium Resistivity | Copper Resistivity |
|---|---|---|
| (K) | (Ω m) | (Ω m) |
| 20 | 7.48E−12 | 3.57E−10 |
| 50 | 4.76E−10 | 9.29E−10 |
| 77 | 2.20E−09 | 2.39E−09 |
| 100 | 4.40E−09 | 3.94E−09 |
| 150 | 1.00E−08 | 7.45E−09 |
| 293 | 2.65E−08 | 1.69E−08 |
| 500 | 5.02E−08 | 2.95E−08 |

As such, there are significant gains that can be made from the use of coolant, which may already be present in propulsion systems, for converting the cable material into a hyperconducting state.

Table 1 shows that below 77 Kelvin, the resistivity of aluminium drops below that of copper as the lightweight aluminium enters the hyperconductive region. Therefore, the system may advantageously use liquid hydrogen to cool the aluminium components, as liquid hydrogen has a temperature of less than 30 Kelvin. The use of liquid hydrogen as a coolant thereby enables the aluminium to be cooled sufficiently to be more electrically conductive than copper.

As can readily be understood, as the resistivity of the aluminium drops below that of copper, and accounting for the lower density of aluminium when compared to copper, extremely large gains in the total size and mass of required cable can be made.

Referring now to FIG. 1B, there is shown a hyperconductive electrical transmission 100 comprising an aluminium 1 MW cable 110 at 270V DC (below the Paschen minimum). Compared to the six copper cables 11, 12, 13, 14, 15, 16 of 16 mm diameter resulting in a total transmission 10 diameter of 55 mm, the hyperconducting equivalent 110 has a diameter of around 2.4 mm; see measurement C in FIG. 1B. Clearly this is a significant size reduction in the electrical transmission size from transmission 10 of FIG. 1A to transmission 100 of FIG. 1B. Further, considering the relative densities, the conductor mass per unit length of electrical transmission 100 is around 16.5 g/m compared to around 7.2 kg/m for transmission 10. Therefore, there is also a significant weight saving when using the hyperconductive arrangement shown in FIG. 1B.

The system 100 presented herein therefore is around 400 times lighter than modern systems and are electrically far more efficient, using less than half the voltage (FIG. 1A uses 700V AC, while FIG. 1B uses 270V DC). Calculations showing this significant weight reduction are shown in Tables 2 and 3.

Therefore, there are significant gains to be had in the use of a hyperconducting electrical transmission. This may also be referred to as hyperconducting electrical bus, hyperconducting bus, hyperconducting cable.

An option for cooling the cable to the hyperconductive region is to immerse the cable in liquid hydrogen, however this may not be the most efficient or effective method. Therefore, examples of efficient and effective cable configurations are now discussed.

The present hyperconducting cable provides a large number of efficiency gains over present systems. In particular, the use of a hyperconducting cable in a network results in increased efficiency and reduced mass when compared to a More-Electric Aircraft (MEA) network or even a high voltage (HV) network. The aluminium hyperconducting network at 20 Kelvin is compared to MEA and HV networks at room temperatures while delivering 1 MW in power, as shown in Table 2.

TABLE 2
Showing Properties of the presently disclosed Hyperconducting
Cable in a Network against an MEA Network and a HV Network

| | 20 Kelvin | MEA | HV |
|---|---|---|---|
| | Hyperconducting | Network | Network |
| | Cables in a Network | (at 270 | (at 3 |
| | (at 270 V DC) | V DC) | kV DC) |
| Resistivity (Ω m) | 7.48E−12 | 2.65E−08 | 2.65E−08 |
| Normalized difference | 1 | 3542 | 3542 |
| in Resistivity to 20 K | | | |
| Losses (I²R) (W) | 49 | 172,719 | 5,596 |

Clearly there are electrical efficiency gains provided by use of the hyperconducting cable of the present disclosure in a network. The systems of Table 2 are a 1 MW electrical network using a 10 m aluminium bus bar.

Additionally, there are structural gains specifically in relation to weight. Table 3 uses the same parameters as Table 2, and only allows the system a 5° C. temperature rise over 1 minute.

TABLE 3
Showing Properties of the presently disclosed Hyperconducting
Cable used in a Network against an MEA Network and a HV Network

| | 20 Kelvin | MEA | HV |
|---|---|---|---|
| | Hyperconducting | Network | Network |
| | Cables in a Network | (at 270 | (at 3 |
| | (at 270 V DC) | V DC) | kV DC) |
| Cable AWG gauge needed | 10 | 0000 | 0000 |
| to keep temp. rise below | | | |
| 5° C. per minute | | | |
| Number of cables needed | 1 | 210 | 7 |
| Weight of Cables (kg) | 0.14 | 607.9 | 37.6 |
| Volume of conductor | 53 | 225,162 | 13,939 |
| needed (mm²) | | | |

Table 3 clearly shows the advantages in terms of weight and volume of the hyperconducting electrical cable used in a network disclosed herein.

As shown above, hyperconducting aluminium may be used as a conductor for the bus bar and the feeder cables. The aluminium may be cooled by the LH₂ from a liquid cryogen store, either by being fully immersed in LH₂ or used as a current carrying pipe. The hyperconductor will then be enclosed in dielectric and insulation for beneficial behaviour when handling high voltages.

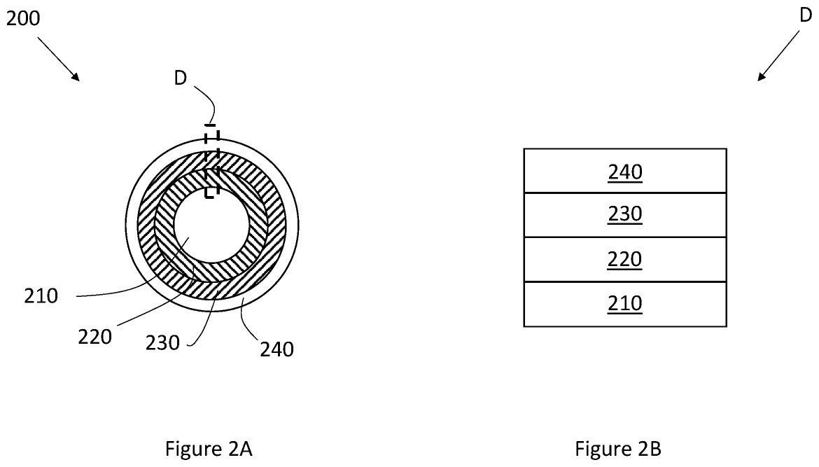

Referring now to FIGS. 2A and 2B, there are shown schematic views of a new electrical transmission arrangement 200 for a vehicle. FIG. 2A shows a schematic cross-sectional view of an electrical transmission arrangement 200. FIG. 2B shows an enlarged schematic of portion D of FIG. 2A.

FIG. 2A shows a transmission 200. The transmission 200 has a central core of cryogen, for example liquid hydrogen 210. The transmission 200 has a layer of aluminium 220 surrounding the hydrogen 210. The transmission 200 has a layer of dielectric 230 surrounding the aluminium layer 220. The transmission 200 has an outer surface of insulation 240. The insulation 240 surrounds the dielectric 230.

The cable arrangement 200 of FIG. 2A allows transport of both electrical signals and cryogen 210, therefore this cable provides a double use in a system that uses cryogen and requires transport of that cryogen. Furthermore, the cryogen transport also provides the function of cooling of the aluminium cable 220.

For clarity, FIG. 2B shows an enlarged view of portion D of FIG. 2A. The layers are clearly shown as cryogen 210 in the centre (bottom of FIG. 2B), then aluminium 220, dielectric 230 and insulation 240 on the outermost layer (top of FIG. 2B).

The dielectric 230 and insulation 240 layers provide electrical isolation of the electrical energy being carried in the electrical conductor 220. The cryogen 210 may also act as an electrical insulator.

In use, the aluminium 220 contains the cryogen 210 which may be pressurized liquid hydrogen or cryogenic gaseous hydrogen, while also carrying the current to the required loads. The aluminium pipe 220 would then be surrounded by a layer of dielectric 230 and insulation 240. To simplify manufacturing, this could be a spray on foam or cryogenic blanket and/or a vacuum, as this would allow detection of leaks and is a suitable insulator. Such a construction, and construction techniques, reduces complexity of manufacturing in comparison to an electrical transmission that is immersed in liquid hydrogen which would need to be mechanically supported.

The aluminium pipe 220 is partially supported by the cryogen 210 as the tensile strength increases by up to 40% in cryogenic temperatures. The aluminium pipe 220 can also be strengthened by doping it with graphene, which only has a negligible effect on the conductivity of pipe 220. It is also possible for the aluminium 220 to be supported by a simple, inert and lightweight former (such as a glass reinforced plastic), which would aid in its robustness. As such, these manufacturing steps can be taken to improve the robustness of the design of cable 200.

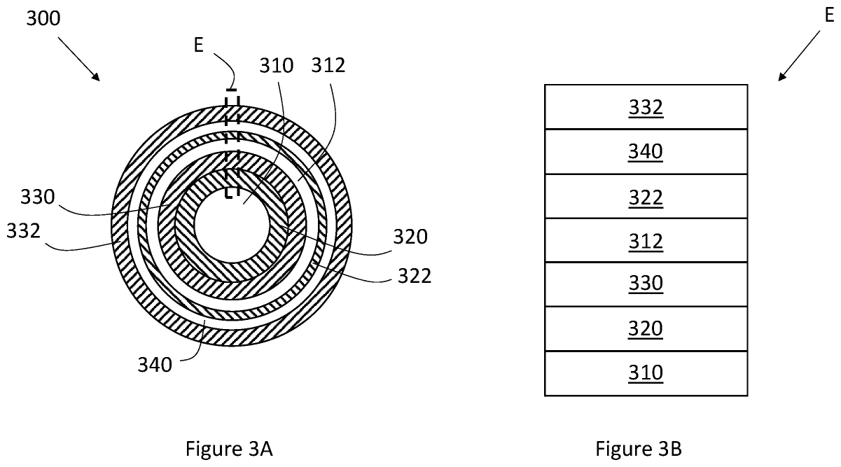

Referring now to FIGS. 3A and 3B, there are shown schematic views of a new electrical transmission arrangement 300 for a vehicle. FIG. 3A shows a schematic cross-sectional view of an electrical transmission arrangement 300. FIG. 3B shows an enlarged schematic of portion E of FIG. 3A.

FIG. 3A shows a transmission 300. The transmission 300 has a central core of cryogen, for example liquid hydrogen 310. The transmission 300 has a layer of aluminium 320 surrounding the hydrogen 310. The transmission 300 has a layer of insulation 330 surrounding the aluminium layer 320. The transmission 300 has a layer of gaseous cryogen 312 surrounding the layer of insulation 330. The transmission 300 has a second layer of aluminium 322 surrounding the layer of gaseous cryogen 312. The transmission 300 has a layer dielectric 340 surrounding the second layer of aluminium 322. The transmission 300 has an outer surface of insulation 332. The insulation 332 surrounds the dielectric 340.

In use, the cable 300 may transport electrical current along the inner aluminium pipe 320 that holds, and is cooled by, the central cryogen 310, which may be liquid hydrogen. The outer aluminium pipe 322 holds and transports (together with the inner aluminium pipe 320 and the insulation 330) a second cryogen 312. The second cryogen 312 may be a gaseous hydrogen. The second cryogen 312 may be a returning cryogen having been used in some manner. This may be via use in a fuel cell or heat exchanger function. The returning cryogen 312 may be at a temperature sufficient to put aluminium into the hyperconducting region. Alternatively, the returning cryogen 312 may not be at a temperature sufficient to put aluminium into the hyperconducting region. The returning cryogen 312 may therefore be in a gaseous phase. The returning cryogen 312 may be in a high pressure gaseous phase. The returning cryogen 312 provides further protection against external heat from reaching and impacting the cryogen 310 and therefore the hyperconductive inner aluminium pipe 320.

Using the same conduit to carry the return gaseous hydrogen 312 from locations where the cryogen 312 may have performed a function, such as heat exchange at the motors of a propulsion system for a vehicle, would provide two advantages. The first relates to saving the weight of having two individual cables, one carrying the outward liquid cryogen and one carrying the inward gaseous cryogen. There would be less total material in particular in terms of insulation, support, and dielectric materials. The second advantage relates to cooling the opposite polarity conductors with the gaseous hydrogen (in FIG. 3A, the opposite polarity conductor is second, outer aluminium pipe 322). The opposite polarity conductor may act as a shield, protecting the cable 300 from stray electric and magnetic fields and vice versa. The opposite polarity conductor may also act as a ground for the components to which the cable is connected.

For clarity, FIG. 3B shows an enlarged view of portion E of FIG. 3A. The layers are clearly shown as cryogen 310 in the centre (bottom of FIG. 3B) of cable 300, then aluminium 320, insulation 330, second cryogen or gaseous phase cryogen 312, second aluminium layer 322, dielectric 340 and insulation 332 on the outermost layer (top of FIG. 3B).

Polymer dielectrics, which are used in typical superconducting and high voltage cables, typically have dielectric strengths of around 10-15,000 V per mm. Gaseous hydrogen under normal circumstances has a lower minimum voltage breakdown than air. However, using liquid hydrogen and increasing the pressure to 3 bar (which is around the required pressure for use of cryogenic hydrogen in a Fuel Cell) increases the dielectric strength to 9,000 V per millimetre. This is comparable to polymer dielectrics. As such, the cable can be designed to use high pressure liquid hydrogen instead of a polymer dielectric which leads to a reduction in mass of the cable.

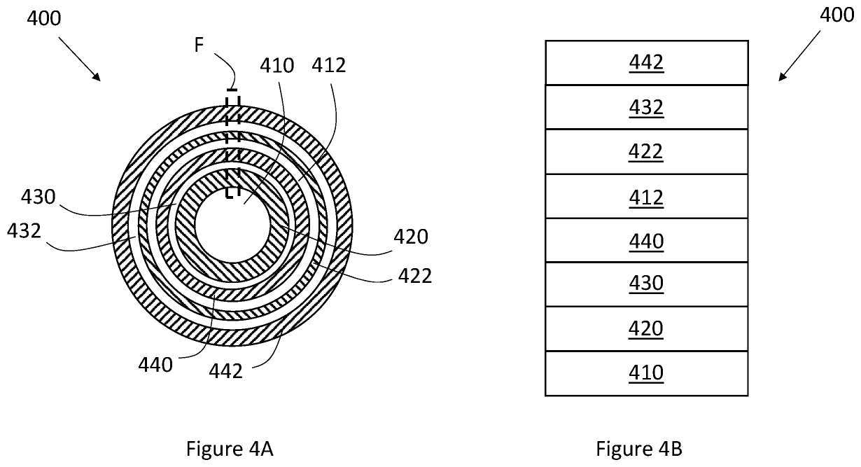

Referring now to FIGS. 4A and 4B, there are shown schematic views of a new electrical transmission arrangement 300 for a vehicle. FIG. 4A shows a schematic cross-sectional view of an electrical transmission arrangement 400. FIG. 4B shows an enlarged schematic of portion F of FIG. 4A.

FIG. 4A shows a transmission 400. The transmission 400 has a central core of cryogen, for example liquid hydrogen 410. The transmission 400 has a layer of aluminium 420 surrounding the hydrogen 410. The transmission 400 has a layer of dielectric 430 surrounding the aluminium layer 420. The transmission 400 has a layer of insulation 440 surrounding the dielectric 430. The transmission 400 has a layer of gaseous cryogen 412, which may be gaseous hydrogen, surrounding the layer of insulation 440. The transmission 400 has a second layer of aluminium 422 surrounding the layer of gaseous cryogen 412. The transmission 400 has a second layer dielectric 432 surrounding the second layer of aluminium 422. The transmission 400 has an outer surface of insulation 442. The insulation 442 surrounds the second layer of dielectric 432.

As mentioned above, the cryogen 412, which may be returning cryogen 412, may be carried in the second aluminium pipe 422. In this way, the cable 400 provides thermal and electrical shielding to both aluminium tubes 420, 422 by the cryogen 412, dielectric 430, 432 and insulation 440, 442. In this way, a very robust cable is provided that carries cryogen while enabling effective current carrying capacity by virtue of the hyperconductive region and high resilience against shorting by having a high breakdown voltage.

For clarity, FIG. 4B shows an enlarged view of portion F of FIG. 4A. The layers are clearly shown as cryogen 410 in the centre (bottom of FIG. 4B) of cable 400, then aluminium 420, dielectric 430, insulation 440, second cryogen or gaseous phase cryogen 412, second aluminium layer 422, second dielectric layer 432 and second insulation layer 442 on the outermost layer (top of FIG. 4B).

It may be that construction of large lengths of transmissions, as shown in FIGS. 2 to 4, is not desired, whether for construction ease or otherwise. A solution is that sections of transmissions could be formed separately and then joined together.

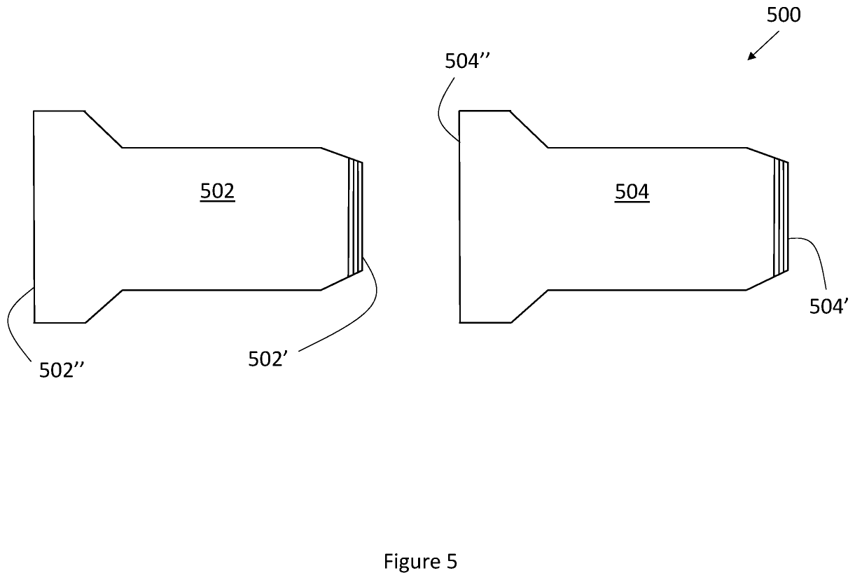

As shown in FIG. 5, there is shown a schematic of a spigot and socket joint between two portions 502, 504 of a transmission 500. In the example shown in FIG. 5, portion 502 of transmission 500 has a first end 502′ and a second end 502″. Portion 504 first end 504′ and a second end 504″. The first end 502′ of portion 502 arranged to connect to the second end 504″ of the second portion 504. The first end 502′ of portion 502 is smaller than the second end 504″ of the second portion 504 thereby providing a good fit when connected.

In an arrangement of the system of FIG. 5, a clamp or similar fixing may be used to provide a connection between two portions 502, 504 of cable 500. This is advantageous easier to construction than a system requiring terminations and connectors within portions of the cable. Alternatively, or additionally, the portions 502, 504 may be connected via interference fit such as a screwed connection or the like. As one portion (in the example shown, portion 502) can be connected to a further portion (in the example shown, portion 504), the cable or transmission 500 can be constructed from a series of smaller cables or transmissions to provide a suitable length of transmission 500.

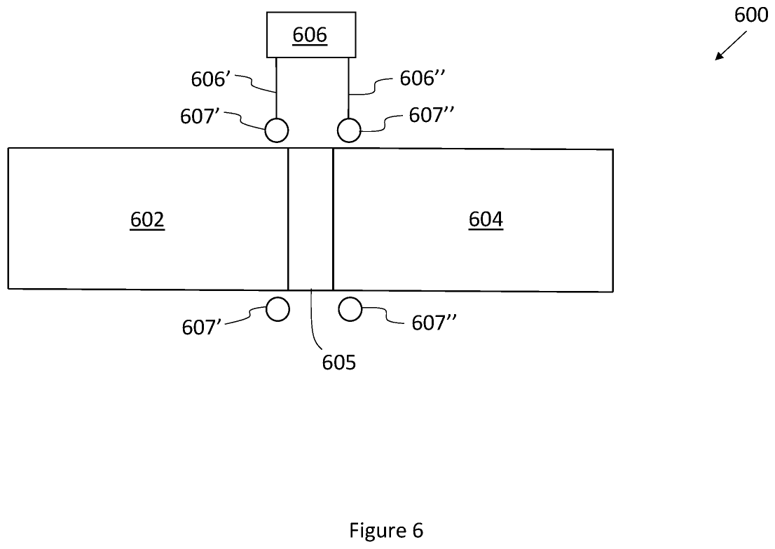

Use of clamps, or similar fixing, may be advantageous as the clamps may provide a connection for other components such as fault protection and power electronics. Such components may be connected to an interrupted section of cable to provide best readings. Further, such an interrupted section could be made of a ring of insulating material that would interrupt the current flow but not the Liquid Hydrogen supply. A schematic is shown in FIG. 6.

As shown in FIG. 6, there is shown a schematic of a joint between two portions 602, 604 of a transmission 600. The transmission 600 is comprises two hyperconducting conduit portions 602, 604. The two portions 602, 604 are separated by an interrupter 605. The interrupter 605 is an insulating material to provide a break in the conducting circuit. This ensures the current through the two portion 602, 604 is passed to electrical component 606. Electrical component 606 is connected to the portions 602, 604 by electrical conductors 606′ and 606″ respectively. The electrical conductors 606′ and 606″ are connector to electrical clamps (or O-rings) 607′ and 607″ respectively. The interrupter 605 may be formed from rubber to provide flexibility in the transmission 600.

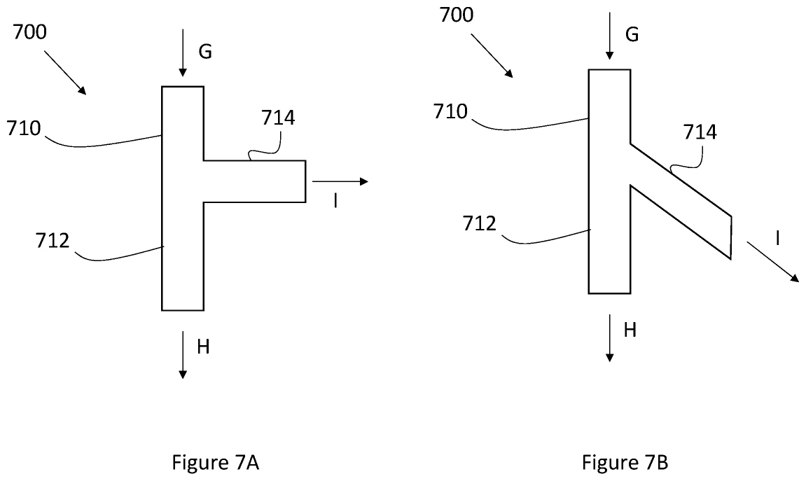

Other arrangements for combining the electric busbars can be envisaged. In particular, if a transmission needs to be split in two, for example, to transport the liquid hydrogen to two different places, a junction may be used in the transmission. This may be a T-junction, or a non-90 degree angled junction (a Y-junction) as shown in FIGS. 7A and 7B.

In particular, FIG. 7A shows a transmission 700 with portions 710, 712 and 714. First portion 710 shows the main entry portion of the transmission 700. Liquid hydrogen travels into first portion 710 as shown by arrow G. Some of the liquid hydrogen that enters the first portion 710 continues into second portion 712 and exits the second portion 712 in the direction of arrow H. Some of the liquid hydrogen that enters the first portion 710 continues into third portion 714 and exits the third portion 714 in the direction of arrow I. FIG. 7B shows a similar arrangement, with similar numerals used to referred to similar components of transmission 700. The third portion 714 can be seen to be at a non-90 degree angle to the first portion 710.

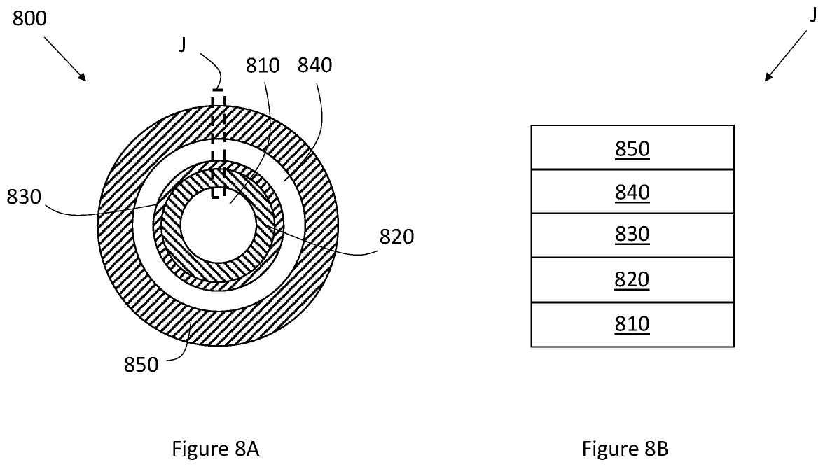

In examples of the arrangement described herein, the cable may comprise a former to support the aluminium (or other metal) forming the main conductive portion of the cable. Using a former allows reduction of the total amount of aluminium used in the cable. In an example, the former is made of a strong, lightweight, non-reactive material (such as glass reinforced plastic) then this may reduce the weight of the cable. A schematic of a possible former design is shown in FIGS. 8A and 8B.

FIG. 8A shows a transmission 800. The transmission 800 has a central core of cryogen, for example liquid hydrogen 810. The transmission 400 has a layer of former 820 surrounding the hydrogen 810. The transmission 800 has a layer of aluminium 830 surrounding the former layer 820. The transmission 800 has a layer of dielectric 840 surrounding the aluminium 430. The transmission 800 has a layer of insulation 850 surrounding the layer of dielectric 840.

For clarity, FIG. 8B shows an enlarged view of portion J of FIG. 8A. The layers are clearly shown as cryogen 810 in the centre (bottom of FIG. 8B) of cable 800, then former 820, aluminium 830, dielectric 840 and insulation 850 on the outermost layer (top of FIG. 8B).

The example shown in FIGS. 8A and 8B show a cable with a much smaller cross section of aluminium conductor 830. In the example, the aluminium 830 is not in contact with the liquid hydrogen 810 and therefore this design may result in the aluminium 830 not being cooled as in arrangements above wherein the aluminium 830 and cryogen 810 abut.

The arrangement shown in FIGS. 8A and 8B are advantageous as the use of the former 820 and aluminium 830 result in a flexible cable 800. The aluminium 830 may be in the form of a hyperconducting tape wound around the inner former 820. The former 820 then supports the aluminium 830 which may help in preventing the conductor dropping to the bottom of the cryogenic fluid which would result in uneven cooling on the conductor. This may happen in layered cable wherein the aluminium is surrounded by a cryogen layer or the like. Mechanical supports assist in holding the aluminium in a central position within the cryogen to allow for even cooling. The aluminium, or other suitably conductive component, may be in the form of a tape or pipe or other similar constructions.

Arrangements shown herein may be intermixed, such that components and arrangements from Figures may be used on other Figures. For example, the cable 800 of FIGS. 8A and 8B may have a second cryogenic portion 412 (which may be gaseous or the like), as shown in FIGS. 4A and 4B. The advantages of these layers has been explained herein and so the layers, and their associated advantages, can be ported between all examples described herein.

The support of the aluminium layer when immersed in cryogenic fluid can be useful to improve the structural stability of the cable. As such, additional support structures can be introduced to the examples described herein. A trade off to consider is the additional complexity of construction of the cable, the complexity associated with arranging any connectors and terminations for different portions of cable, and the subsequent impact of cryogen flow through the cable.

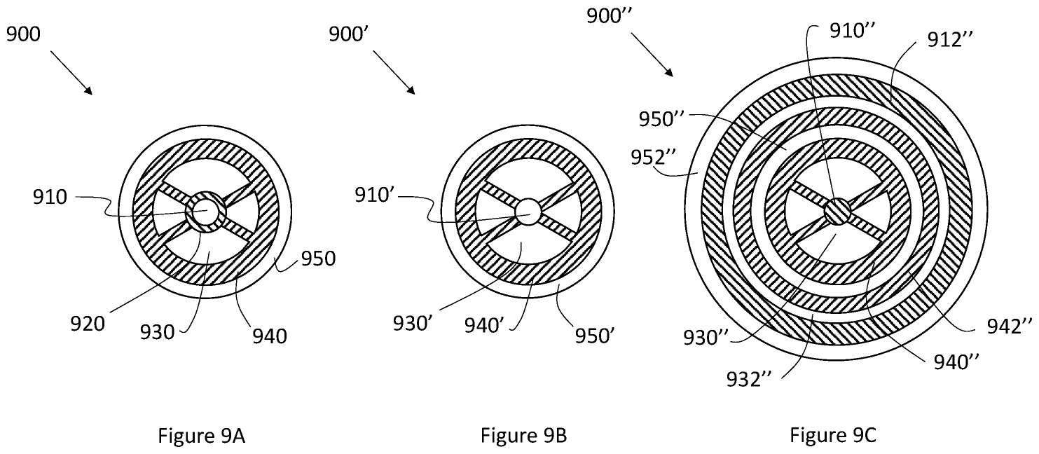

Referring now to FIG. 9A, an example of a transmission 900 is shown. The transmission 900 has a central core conductor 910. In an example, this core conductor 910 is made from aluminium for the advantages mentioned above. There is a layer of dielectric 920 around the central conductor 910. In the example shown in FIG. 9A, there is a support structure 940 present. The support structure 940 with inwardly projecting supports connects to the dielectric layer 920. Between the support structure 940 there is a cryogen 930 for maintaining the central core in a hyperconducting situation. The cryogen 930 may be liquid hydrogen for the advantages mentioned above. A layer of insulation 950 surrounds the support structure.

As mentioned above, the various layers of these transmissions can be varied to ensure that the cable conducts electricity and carries cryogen effectively, efficiently and safely. Other shown in FIGS. 9B and 9C show such examples.

Referring to the example shown in FIG. 9B, a cable 900′ is shown. The cable 900′ contains a central conductor 910′, cryogen 930′, a support structure with supports 940′ and an outer layer of insulation 950′. In this example, the cryogen 930′ may be high pressure liquid hydrogen which acts as an efficient dielectric, as mentioned above. In this way, space in the cable 900′ can be saved by not using the dedicated dielectric layer.

In the example shown in FIG. 9C, a cable 900″ is shown. While the cable 900″ is larger than those in FIGS. 9A and 9B this has been enlarged for clarity of layers and not indicative of a necessarily larger cable.

The cable 900″ contains (going outward radially from the centre of the cable 900″) a central conductor 910″, cryogen 930″, support structure with supports 940″, insulation layer 950″, second support layer 942″, a layer of high pressure cryogen, possibly in gaseous form, 912″, a second conductor layer 912″ and an outer layer of insulation 952″. In this example, a combination of both the current carrying and the supported inner hyperconducting conductor is shown. The high pressure cryogen 912″ may be gaseous hydrogen.

Thicker or additional layers of formers may be used to mechanically support the aluminium and so reduce the total amount of aluminium needed in the cable. Dielectrics can be used in place of high pressure liquid hydrogen. An advantage from use of dielectrics is that the high pressure cryogen is not required and therefore the dangers and difficulties of handling such cryogen can be negated somewhat. The use of dielectrics provides more robustness in light of any failure in the cooling, as the dielectric would continue to be operational.

Therefore, there is described herein an effective and efficient electrical transmission. This system provides a number of advantages as discussed above. Further advantages include, by enabling easier use of transport of cryogen, easier integration of the use of clean fuels in the generation of propulsion either via combustion of cryogen or via fuel cell electrical generation. This system therefore tangentially assists in the reduction of harmful emissions in modern propulsive systems.

The use of pure, and cryogenic, oxygen and hydrogen enables substantially smaller (more power dense) and lighter mass (higher specific power) propulsion generation in place of modern propulsive systems. Use of liquid hydrogen and oxygen (i.e. as cryogens) also provide advantages in power density and cooling factors.

Although the electrical transmissions described herein are discussed as being used with propulsion systems mostly in terms of aircraft, other vehicles such as spacecraft and submarines or the like may carry oxygen, liquid oxygen, or gaseous or liquid hydrogen, for use in propulsion systems. Each of these would be benefitted by the presently disclosed cable arrangement.

Numerous advantages are provided by a production of propulsion from cryogens rather than say via fossil fuels. The production of water in place of harmful gaseous emissions (NOx, CO2 etc) has clear associated advantages. Furthermore, operation of a vehicle can occur with significantly reduced noise levels. In a particular example, take off and landing phases for aircraft can occur with significantly reduced noise levels due to the lack of high velocity exhaust gas.

Applications for this cable arrangement therefore may include automotive, space, domestic or commercial and so forth.

A further benefit of the use of fuel cells over combustion engines as disclosed herein is that microbe colony formation which occurs in existing aircraft kerosene fuel tanks is avoided. The cleaning of such tanks currently requires detergent insecticide cleaners that are somewhat environmentally damaging. In some cases this cleaning may be after each long haul flight. Therefore, the reduction in cleaning has further environmental benefits.

1. An electrical transmission comprising:
an electrical conductor; and,
a cryogen carrying portion arranged so that, in use, cryogen is carried in the cryogen carrying portion to maintain the conductor in a hyperconductive state.

2. An electrical transmission according to claim 1, wherein the cryogen carrying portion is formed by the electrical conductor.

3. An electrical transmission according to claim 1, wherein, in use, the cryogen carried in the cryogen carrying portion is arranged to provide an electrically insulating function.

4. An electrical transmission according to claim 1, further comprising:
a second electrical conductor; and,
a cryogen returning portion formed between the electrical conductor and the second electrical conductor, the cryogen returning portion arranged so that, in use, a cryogen is returned in the portion formed between the electrical conductor and the second electrical conductor.

5. An electrical transmission according to claim 4, wherein the cryogen returning portion is arranged between the cryogen carrying portion and an outer edge of the electrical transmission.

6. An electrical transmission according to claim 1, further comprising a former arranged to abut the electrical conductor.

7. An electrical transmission according to claim 1, further comprising a support structure arranged to support the electrical conductor.

8. An electrical transmission according to claim 1, further comprising electrical insulation arranged to form an outer layer of the electrical transmission.

9. An electrical transmission according to claim 1, further comprising a dielectric arranged to provide electrical insulation within the electrical transmission.

10. An electrical transmission according to claim 1, wherein the electrical conductor is formed of aluminium.

11. An electrical transmission according to claim 1, wherein the electrical transmission comprises:
a first electrical transmission portion;
a second electrical transmission portion; and
a clamp,
wherein the first electrical transmission portion and the second electrical transmission portion are connected by the clamp.

12. An electrical transmission according to claim 11, wherein the electrical transmission further comprises an insulating interrupter, arranged between the first electrical transmission portion and the second electrical transmission portion.

13. An electrical transmission according to claim 1, wherein the electrical transmission comprises a T- or Y-junction.

14. An aircraft electrical system comprising the electrical transmission of claim 1.

15. An aircraft comprising the electrical transmission of claim 1.

16. A method of carrying electrical signals along an electrical transmission, the method comprising:
cooling, with a cryogen, a conductor to the hyperconductive region;
providing an electrical signal to a conductor,
continuing to cool the conductor,
thermally and electrically insulating the conductor.
